(19) United States
(12) Patent Application Publication
(10) Pub. No.: US 2009/0058374 A1
(43) Pub. Date: Mar. 5, 2009

(54) HIGH EFFICIENCY ALTERNATOR

(76) Inventors: Thomas Evans, Bettendorf, IA (US); Derrick Neice, Davenport, IA (US)

Correspondence Address: MICHAEL P. MAZZA, LLC, 686 CRESCENT BLVD., GLEN ELYN, IL, 60137, US

(21) Appl. No.: 11/846,375

(22) Filed: Aug. 28, 2007

(51) Int. Cl. H02P 9/00; H02P 9/04; H02K 7/18; H02K 11/04; H02K 9/04; H02K 16/00; H02P 9/14

(52) U.S. Cl. 322/28; 310/68 D; 310/62; 310/112; 310/89; 322/29

(57) ABSTRACT

A high efficiency alternator capable of supplying extreme high power output with maximum dissipation of heat. Preferably, the alternator includes dual field coils mounted stationary around a common shaft and dual brushless rotors. The alternator may also include three or more phases, and uniquely wound stator assemblies. The alternator may also include dual, three-phase bridge-type rectifiers and dual voltage regulators. All electrical components are preferably redundant. Air cooling through the interior perimeter of the alternator is preferably provided to cool the housing.

### BACKGROUND OF THE INVENTION

The present invention relates to an alternator for providing electrical power. More particularly, the invention relates to a high-efficiency alternator in which the rotating magnetic field is provided by a dual rotor having dual wound field portions and dual stator wound coils operating together.

The automotive industry has been attempting to increase the output power of motorized vehicle alternators, both at idle and at running speeds. The alternator design most commonly found in vehicles has been used for approximately 25-30 years and is inexpensive to produce, but exhibits very low power levels, e.g., as low as 30 amps at 12 volts DC. The problem is particularly acute at low engine RPMs where primitive cooling methods do not allow high power generation levels in the stator winding, due to excessive heat generation and lack of effective methods of elimination of the heat, leading to very low efficiency.

In addition to the need for higher power, there is also a need to provide alternators that have larger electrical ratings because modern vehicles have many more electrical loads and require much more electrical power. Further, the fuel efficiency of automotive vehicles is closely related to the weight of the vehicle, and it is desirable to decrease the weight of the alternator so as to minimize the total vehicle weight. These three objectives of better cooling, larger electrical rating and decreased weight are each achieved through the present invention.

Brushless alternators (i.e., alternators in which the rotor-induced magnetic field is produced by induction), particularly of the type which may be employed in automobiles for the purposes of recharging automobile batteries, are well known. However, brushless alternators are not necessarily employed in significant numbers because the known prior art brushless alternators tend to be complicated in structure, large in size, and low in efficiency, particularly when considered in terms of energy output per unit volume. Accordingly, brushed-type alternators still find significant use.

Conventional brushless alternators have employed a single field coil with a single (or some cases dual) claw rotating rotor to induce magnetic power to the iron core or stator. However, such alternators may be incapable of producing their full rated output until they are turning at speeds far above their rotational speed at idle.

Accordingly, an object of the present invention is to provide a brushless alternator which meets the three objectives described above.

Yet another object of the invention is to provide high efficiency cooling within the alternator using perimeter cooling tubes or holes that run through the alternator housing.

Yet another object of the invention is to provide a high efficiency brushless alternator able to provide the maximum-rated output voltage and current when a vehicle in which the alternator is installed is operating at low speed.

Yet another object of the invention is to provide redundancy within the alternator using doubles of all electrical components, thereby increasing reliability.

### DEFINITION OF CLAIM TERMS

The following terms are used in the claims of the patent as filed and are intended to have their broadest meaning consistent with the requirements of law. Where alternative meanings are possible, the broadest meaning is intended. All words used in the claims are intended to be used in the normal, customary usage of grammar and the English language.

In a preferred embodiment, an alternator adapted to be used in a vehicle is provided. The preferred alternator comprises a central housing, and first and second stators disposed within the central housing and sharing a shaft as a common longitudinal axis. The stators may each have a winding and a stator winding output. Each stator may have a multiple-phase winding, such as a three-phase winding. First and second rotors may be concentrically and respectively disposed within the first and second stators, for generating alternating current. The rotors may each include a wound field coil portion that is stationary. First and second wound field coils may be mounted in a stationary position in the housing and about the shaft; each of the field coils may be concentrically and respectively disposed within the first and second rotors to allow rotor rotation about the field coils. Voltage rectifier circuits may be connected to the stator winding outputs to provide a voltage rectifier output producing an output voltage for the alternator.

In a particularly preferred embodiment, each stator may be wound with copper wire. Each stator may consist of multiple lamination stacks having multiple phases, such as a three-phase winding.

The central housing preferably includes cooling holes located in the perimeter of the housing for cooling an interior of the housing. A cooling fan is preferably used to pull cooling air through the cooling holes and through the interior of the housing. Cool ambient air may be pulled from a front portion of the alternator, using a rear-mounted fan, through the central housing, to a rear of the alternator using the interior perimeter cooling holes. The cooling holes may be cast or machined within the central housing. The fan may be mounted, for example, on a single central shaft external to the alternator and located at a rear portion of the alternator. Cool ambient air from outside the alternator may be drawn over the voltage rectifier prior to entering the interior cooling holes.

The alternator of the present invention, according to the principles described here, may be a high efficiency alternator capable of producing at least 10 amps per pound of alternator weight, for example. The alternator may be driven by the vehicle engine, and may have a maximum-rated output current.

In a preferred embodiment, the voltage rectifier circuits may include diodes operatively attached by welding to leads on the stators to convert the alternating current to direct current, and voltage regulators operatively attached to the diodes to control and regulate the generated voltage. The voltage rectifier circuits may consist of multiple phase rectifier bridges, such as three-phase bridges rectifying three-phase AC to DC.

Preferably, the electrical components used in the alternator are all redundant. For example, the electrical components used in each voltage regulator may be discrete and redundant.

### SUMMARY OF THE INVENTION

The objects mentioned above, as well as other objects, are solved by the present invention, which overcomes disadvantages of prior alternators, while providing new advantages not believed associated with such alternators.

It has been unexpectedly discovered that significant increases in the efficiency of alternators may be gained by using dual stationary mounted field coil windings to produce a high level of magnetic flux immediately on a single shaft, while the alternator is operating at low speed. Using the high efficiency alternator disclosed here, the inventors were surprised to discover that electrical DC power can be produced beyond nominal even at engine idling speed when installed in an automobile or other vehicle.

At low speed, the full-rated output of the high efficiency alternator may be achieved by coupling the dual field coils on a common shaft, increasing the magnetic flux produced by stators within which the rotors rotate. The supplementing magnetic flux may be produced by field windings multiplied on the shaft magnetics.

In a preferred embodiment, a dual field coil alternator is provided which includes two stators, each having a special stator winding, surrounding each rotor; dual stationary wound field coils lie within the rotors, acting in combination with the stators. The stator wound portion may include a plurality of windings, in multiples of three phases, disposed about its perimeter to produce a magnetic field.

The dual field coil portions may include field windings which may be arranged around the shaft to increase the output, respectively.

In an alternative embodiment of the invention, the dual field coil portions of the assembly may include conversion of the redundant sections of the alternator to be recruited for full power, or dual power conversion, resulting in a doubling of alternator system output electrical power.

It was found that as the alternator RPM increases, the magnetic flux increases even more, producing increased electrical power.

Using the present invention, single field coil design deficiencies are eliminated. A battery may be connected to the alternator as in the normal case, but the battery does not need to be relied upon to absorb any net negative current existing after the battery's other loads.

The preferred embodiment also employs dual voltage regulators that utilize redundancy in the event one of the regulators fails.

### BRIEF DESCRIPTION OF THE DRAWINGS

The novel features which are characteristic of the invention are set forth in the appended claims. The invention itself, however, together with further objects and attendant advantages thereof, will be best understood by reference to the following description taken in connection with the accompanying drawings. The drawings illustrate currently preferred embodiments of the present invention. As further explained below, it will be understood that other embodiments, not shown in the drawings, also fall within the spirit and scope of the invention.

FIG. 1 is a perspective view of a brushless alternator which forms one preferred embodiment of the present invention;

FIG. 2 is a sectional view along reference line 2-2 of FIG. 1 showing an interior portion of the alternator embodiment depicted in that drawing;

FIGS. 3 and 3A are perspective and top views of the alternator shown in FIG. 1.

FIGS. 4 and 5 are rear and front perspective views, respectively, of the front housing assembly without the positive diode plate attached;

FIGS. 6 and 7 are front and rear perspective views of the front housing with the positive diode rectifier plate attached incorporating slotted cooling, with the positive output post mounted on the inside of the front housing assembly, and with the front housing casting used as the negative diode rectifier plate;

FIG. 8 is a cross-sectional view of the alternator showing cooling ports inside the outer perimeter of the alternator between each stator and the exterior of the housing;

FIG. 9 is a perspective view of a preferred embodiment of the rotor or claw used in the alternator of FIG. 1;

FIG. 10 is a side view of the shaft shown in FIG. 2;

FIGS. 11A and 11B are top and side views, respectively, of a rear housing useable with a preferred embodiment of the alternator shown in FIGS. 1-2, to which one of the dual field coils may be attached;

FIGS. 12A and 12B are top and side views, respectively, of a rear fan assembly which may be employed at the rear of the preferred embodiment of the alternator shown in FIGS. 1-2, used to pull air through the alternator from front to rear;

FIG. 13 is an electrical schematic of the alternator showing field coil and stator windings useful in the present invention;

FIGS. 14A-14B are top and partial cross-sectional view of a preferred stator assembly including a three-phase stator winding which extends through slots in each stator, while FIG. 14D is a side view of the stator assembly;

FIG. 14C is a side view of a stator assembly showing output leads from the stator windings;

FIG. 16 is a side and top perspective view of a preferred alternator with the front cover plate removed;

FIG. 17 is a perspective view of a diode useful with the alternator of the present invention;

FIGS. 18 and 19 show output curves of engine speed and alternator speed, respectively, provided by the preferred brushless alternator disclosed here and constructed according to the principles of the present invention;

FIG. 20 is a view similar to FIG. 16 showing the stator leads welded to positive and negative diode pairs;

FIG. 21 is a side and top perspective view of the alternator assembly; and

FIG. 22 is a schematic view showing, in one preferred embodiment, a printed circuit board with dual regulators, including leads to connect to the stator positive plate and the field coil leads.

The components in the drawings are not necessarily to scale, emphasis instead being placed upon clearly illustrating the principles of the present invention.

### DETAILED DESCRIPTION OF THE PREFERRED EMBODIMENTS

Set forth below is a description of what are currently believed to be the preferred embodiments and/or best examples of the invention claimed. Future and present alternatives and modifications to these preferred embodiments are contemplated. Any alternatives or modifications which make insubstantial changes in function, in purpose, in structure or in result are intended to be covered by the claims of this patent.

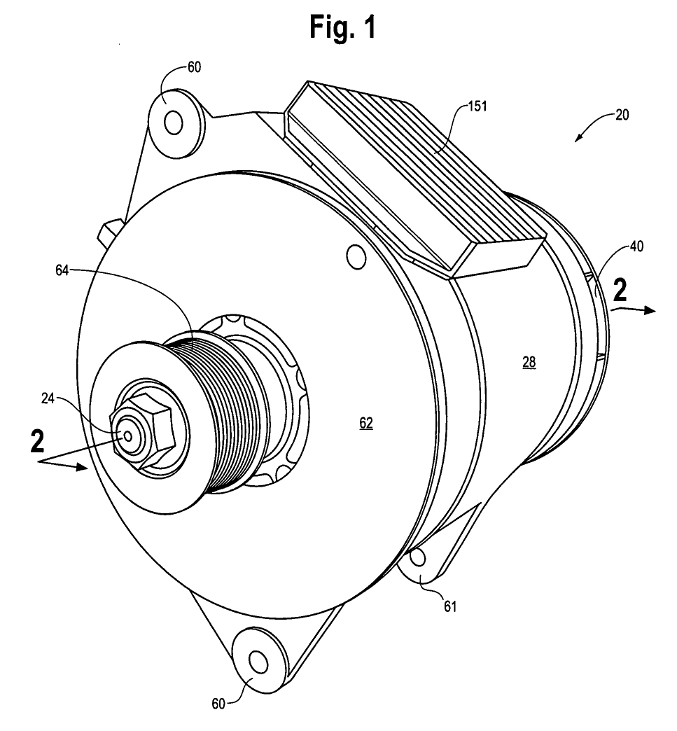

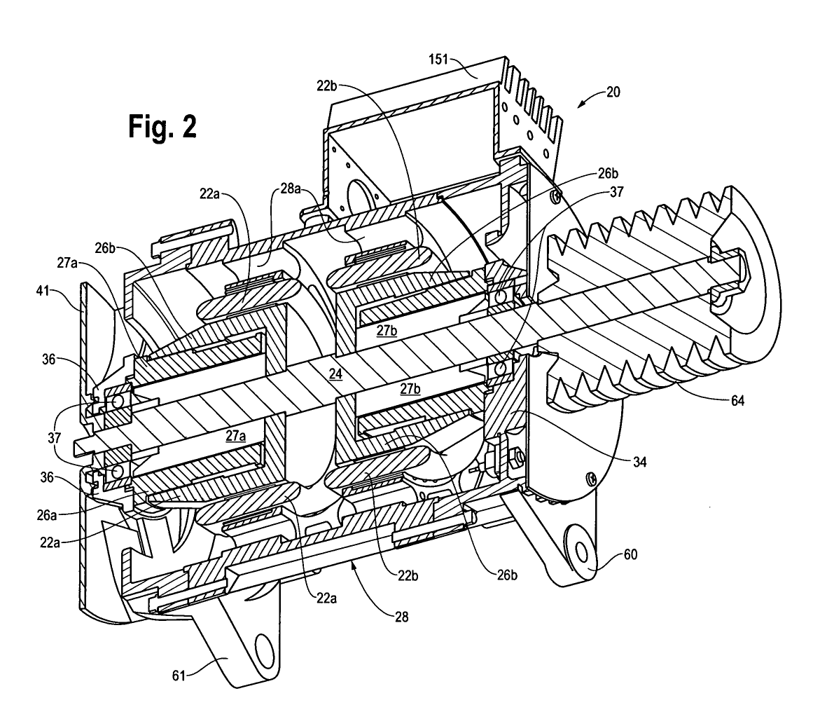

Referring first to FIGS. 1-2, a preferred embodiment of brushless alternator of the present invention is shown, generally referred to by reference numeral 20. Alternator 20 may include front cover plate 62, housing 28 and alternator pulley 64. Rear and front alternator hinge mounts 60, 61, respectively, may be used to mount the alternator to a vehicle chassis, for example. Alternator 20 also includes a regulator, 151 on FIG. 1 mounted on the front housing and wired directly through the housing to the field coils and stators.

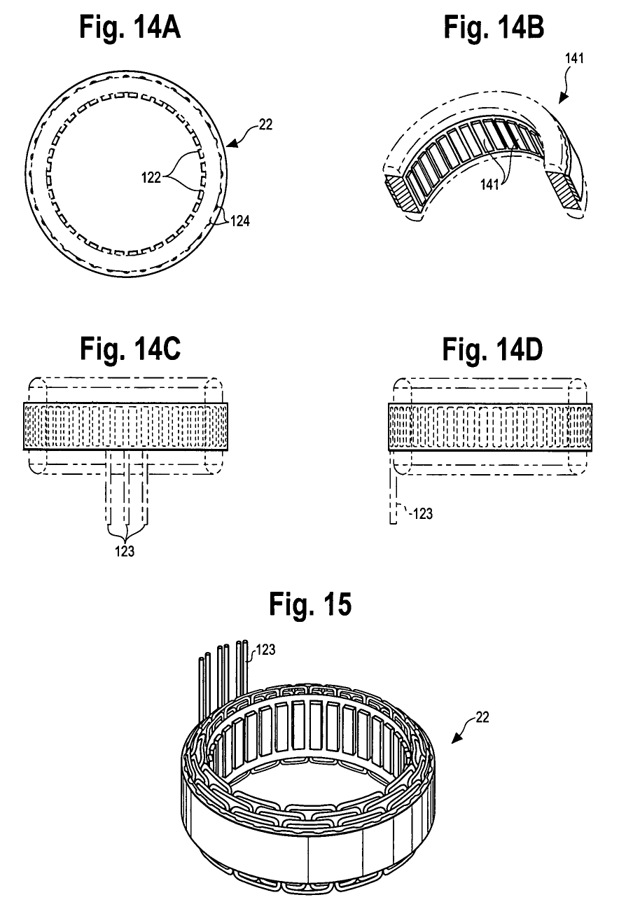

Referring to FIG. 2, brushless alternator 20 may include first and second stators 22a, 22b, having a common longitudinal stator axis coinciding with shaft 24. Each stator may include a three-phase stator winding, wound through a steel laminated core 22A and 22B FIG. 2, which extends through slots 122 FIG. 14A-14D in each stator steel laminated core, formed on the interior of each stator; output leads 123 FIG. 14C electrically connect the stator assembly to the rectifier assembly. Opposed dual rotors or “claws” 26a, 26b may also be provided, each mounted on and turning around a common shaft 24. The dual rotors 26a, 26b rotate about dual wound field coils 27a, 27b, within the first stator region adjacent stator 22b, and a portion of the dual rotors also rotate within the second stator region adjacent stator 22a. The wound field coil portions include field windings which can be excited to produce a magnetic field whenever current is applied.

Referring again to the preferred embodiment of the alternator shown in FIG. 2, this drawing shows a cross-section through the first region of the dual field coils 27a, 27b within

which the horizontally-opposed rotors 26a, 26b spin. The wound field coil core may be conventionally formed from solid cast magnetic metal having the cross-sectional shape shown in FIG. 2, for example, and stacked adjacently along the rotor shaft. Alternately, the wound field coil cores may be constructed using laminated magnetic material.

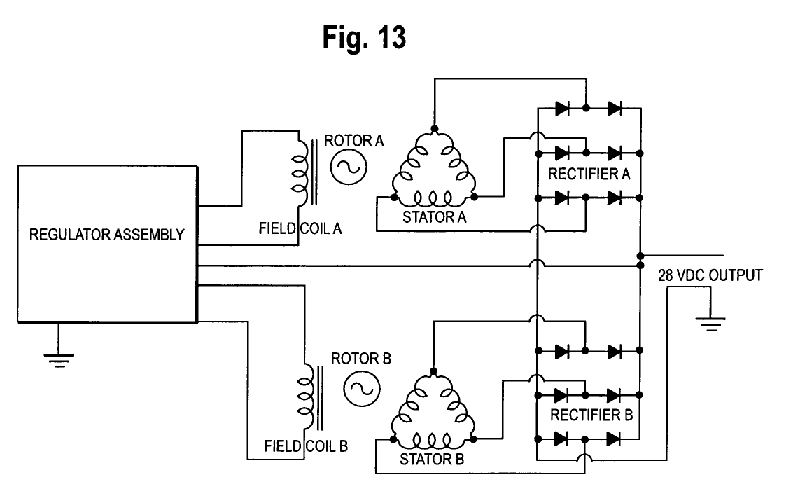

It should now be understood that the first region of the dual field coils and the rotor portion of the alternator act as a dual salient pole alternator to generate magnetic force to the stator windings. This output from the stator windings is provided through output leads (shown in FIG. 13) whenever an excitation current is supplied to the field coil windings.

In the embodiment shown in FIGS. 1-2, the stator portion of the alternator may include identical slots and stator windings. Alternatively, however, the slots may be skewed such that there is a twist equal to the slot pitch of one or more stators along its length. To accomplish this twist, the stator may be formed as a stack of thin laminations of electrical grade steel. Each member of the stack may be rotationally offset from its adjacent members sufficiently to form the twist of one stator slot pitch along its length. The purpose of the twist is to prevent magnetic cogging. In the absence of such a twist, magnetic cogging and unwanted vibration may be created due to variable reluctance caused by slot openings in the air gap between the stator and the rotor.

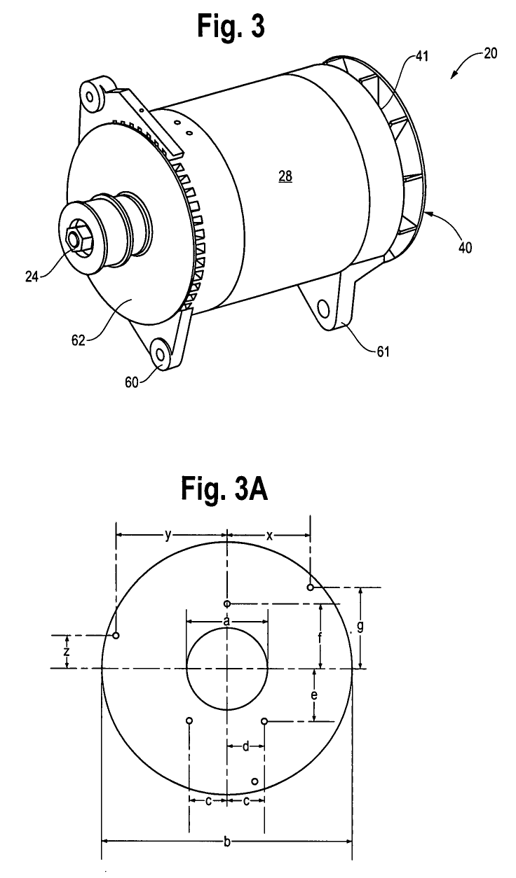

Referring to FIG. 3A, while alternators of alternate dimensions according to the principles of the present invention may obviously be used, the following dimensions were employed in an alternator constructed according to the preferred embodiment of the present invention disclosed here: a (2.50″); b (7.75′); c (1.18″); d (0.88″); e (1.62″); f (2.00″); g (2.52″); h (3.52″); x (2.61″); y (3.48″); and z (1.00″).

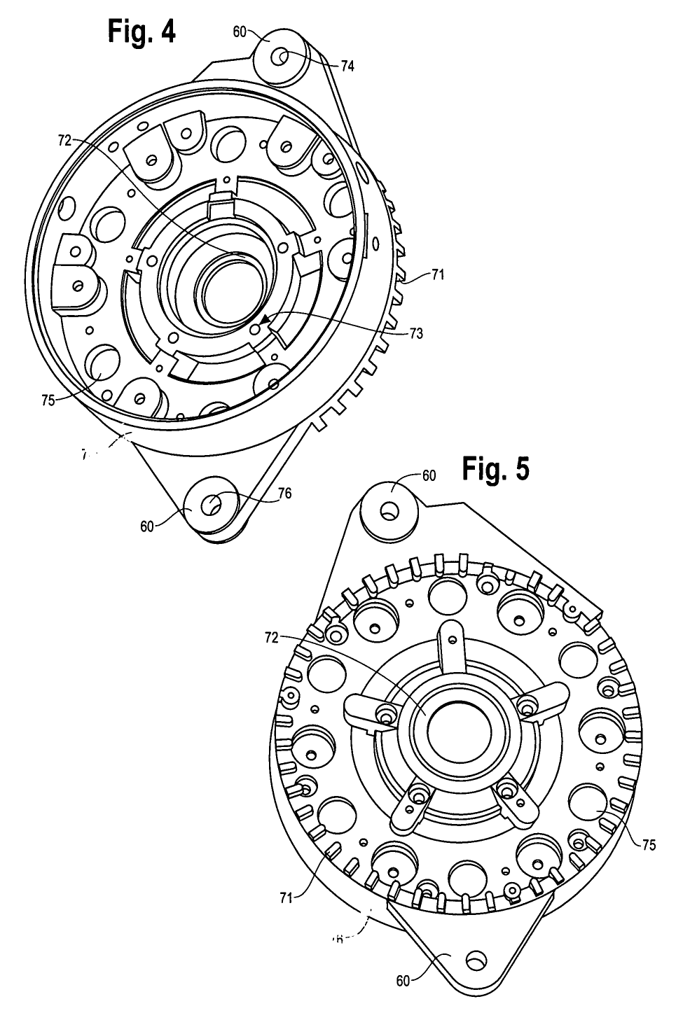

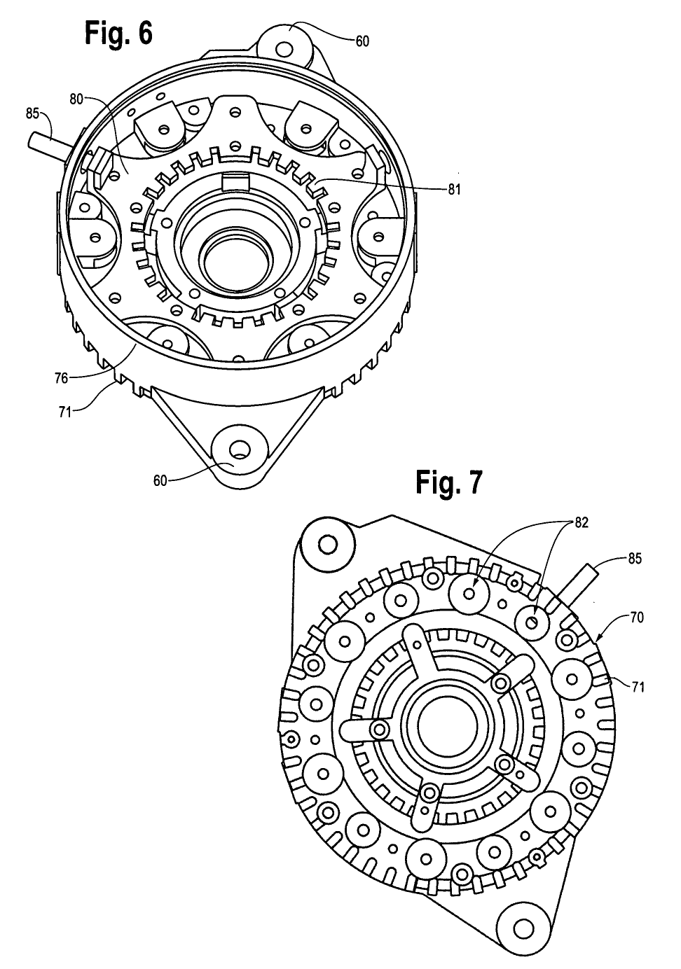

Referring to FIGS. 4-5, front and rear views of front housing assembly 70 of the preferred alternator disclosed here are shown, without positive diode plate 80 attached which is shown in FIGS. 6-7. The positive diode plate may be preferably slotted to increase airflow cooling across its interior dimension. The positive plate also may be preferably electrically isolated from the front housing but in proximity to it to allow the diodes to be connected in pairs without separate diode insulators or epoxy bonding. Alternator front housing 70 includes front housing inlet cooling fins 71, front housing bearing race 72, front housing field coil mount 73, front housing top mount 74, front housing positive diode vent hole 75, and front housing mounting hole 76. The entire front housing assembly serves to rectify AC voltage from the stators and convert it to DC voltage.

Referring back to FIGS. 6-7 of the front housing assembly, diodes, FIG. 17, may be equally spaced 82 around the face of the front housing to facilitate cooling. Negative and positive diodes, FIG. 17, may be placed in alternating spacing, with negative diodes on housing face, (82 of FIG. 7) and positive diodes on positive plate 80 (FIG. 6). The positive plate may float inside the front housing, and may be held in place by five insulators.

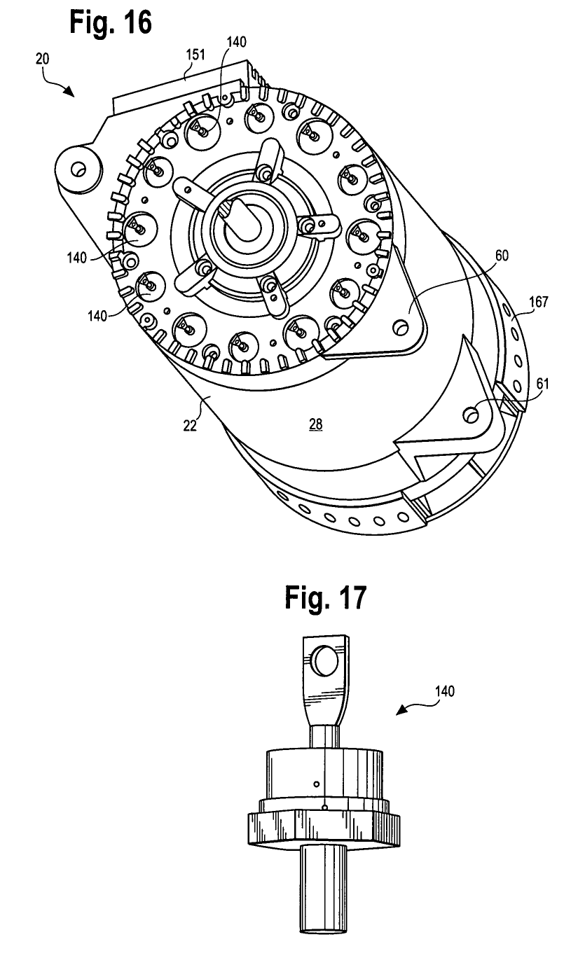

As the alternator shaft of the brushless alternator of the present invention begins to spin, the rotors will induce a voltage in the stator winding which is be rectified to produce a desired output voltage. Referring to FIG. 13, a typical stator winding may be composed, for example, of three legs connected to a full wave voltage rectifier formed by six power diodes. The power diodes may be used to rectify the output and provide charging power to charge the battery and to supply the vehicle with power for accessories over output. Referring to FIG. 16, it was discovered how the stator leads within the rectifier plate may be directly welded to the diodes 140. To accomplish this, each of the twelve diodes (see FIG. 17), six negative and six positive, are equally spaced alternating positive and negative, around the front of the front housing face. Then each of the six stator leads are pulled through the front housing plate to the top of the front housing. Each of the six stator leads is then threaded through one of six small holes between each positive and co joined negative diode pair. The unstranded copper wire is then welded to each diode post. This process completes the entire circuit path of the alternator electrical power output, greatly simplifying assembly and improving reliability. It is believed that the industry has been unable to manufacture a rectifier plate within an alternator without using soldered extra wire or extra mechanical connections to complete a circuit.

The boost of the output provided by coupling the dual field coils to the common magnetic shaft supplies low engine RPM electrical power starts at near engine idle speed. As the engine speed increases, the output from the stator increases and a point is reached at which the desired output current is at a maximum due to the static field winding.

Referring to FIGS. 11A and 11B, rear housing 90 may be used with the preferred embodiment of alternator 20 shown in the drawings. Rear housing 90 includes rear bearing assembly socket 83 and mounting surface 84 for rear field coil. The rear housing assembly serves to center the shaft and hold in place the rear field coil in a stationary position.

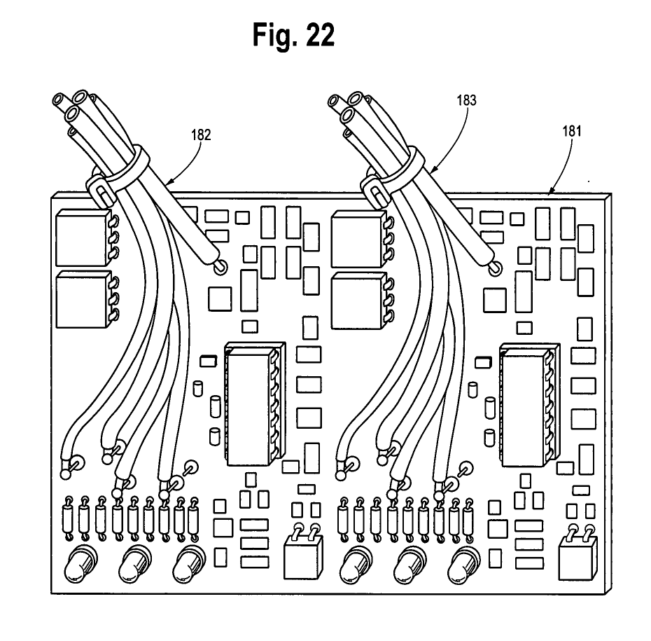

The dual field coil arrangement requires a method of dual regulation as well. Referring to FIG. 22, the preferred regulator incorporates two distinct regulators 182 and 183 with two distinct circuit paths. Preferably, the regulator circuit for each field coil operates distinctly and separately from the other. Thus, regulator redundancy is achieved.

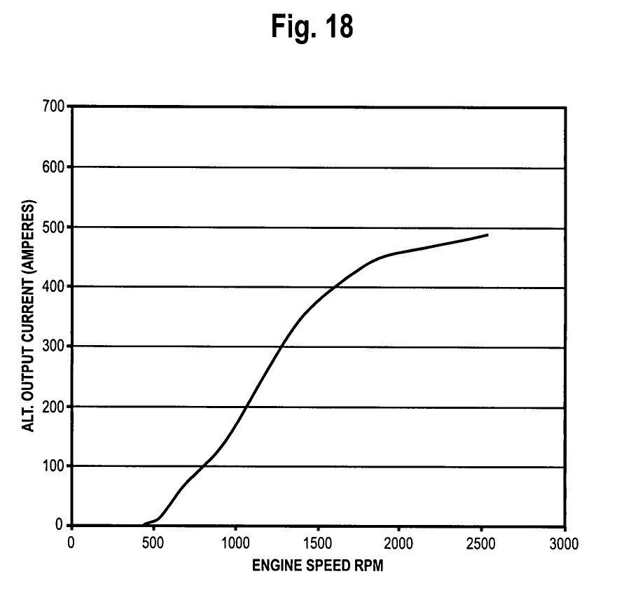

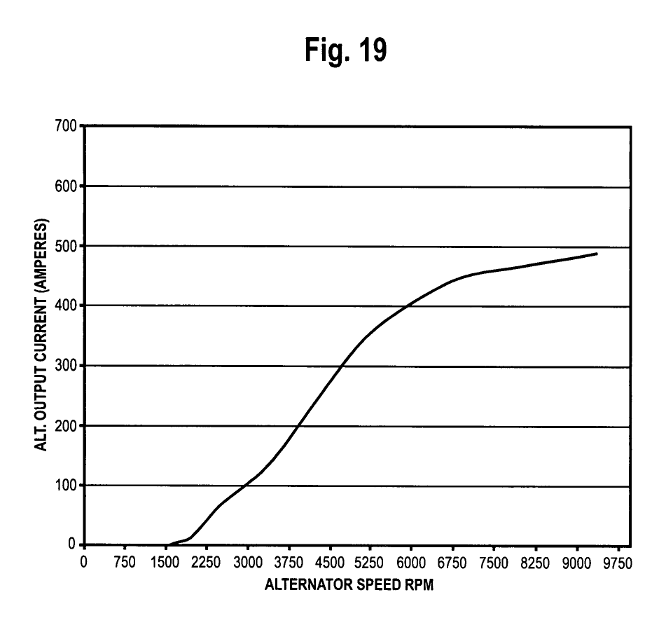

Referring to FIGS. 18-19, engine speed and alternator speed output curves, respectively, are shown for the preferred alternator disclosed here. It can be seen that the electrical output of the system is robust at all speeds of the curve, even at low RPM.

### Construction of the Preferred Embodiment

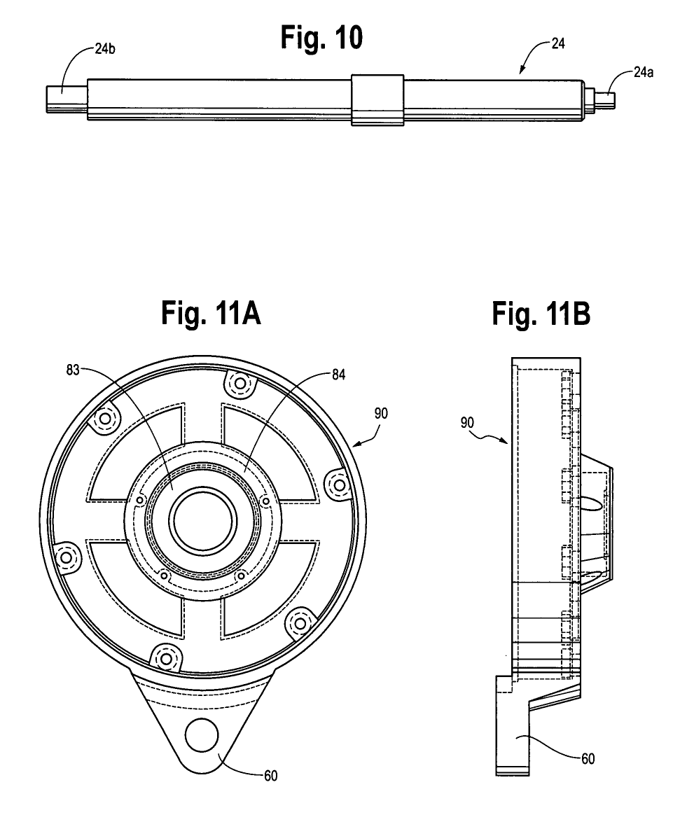

Referring to FIGS. 2 and 10, shaft 24 is preferably made of turned steel, hardened and splined to accept rotors. Shaft 24 may also be threaded on one end 24a (threaded portion not shown) to accept a pulley assembly, and on the other end 24b (threaded portion also not shown) to bolt on to a light-weight aluminum fan (side wall 41 shown only in FIG. 2, but portion of fan 40 shown in FIG. 3).

Rotors 26 may be forged from magnetic material and formed in two distinct planes and welded into one circular cup, as shown in FIG. 9. The center of each rotor cup may be drilled and splined to match the shaft splining. Rotors 26 may be inserted on the shaft using a hydraulic press.

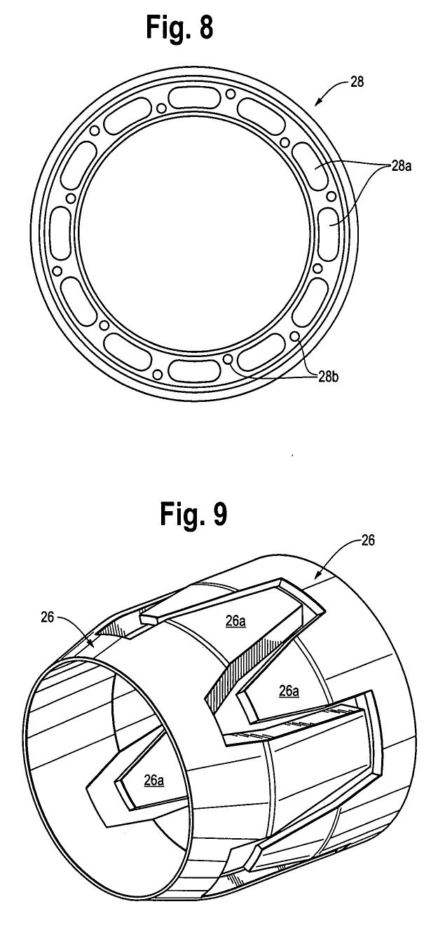

Center housing 28 may be made from cast or machined aluminum and bored for the rotor/shaft assembly. The center housing may also be bored so that stator stacks 22 may be inserted in each end of the housing. Referring to FIG. 8, perimeter cooling elongated holes 28a may be bored in the inside of the outside perimeter. The diameter and shape of each cooling hole 28a may vary depending on the alternator size; one exemplary diameter for the specific alternator embodiment described here is one-half inch. Center housing tap holes 28b allow front and rear housing bolts to secure the assembly together.

The stators 26 may be made of stacked laminations of siliconized steel which are welded or riveted together. An exemplary stack height for the alternator described here is approximately one and one-quarter inch tall. Each stack may then be wound with unstranded copper wire, with shellac coating in a three-phase arrangement, and with each phase having its own leads left six inches long from the stack, resulting in three leads/stator. The stators may then be inserted into each end of the center housing and held in place by small screws. Six stator winding leads, for example, may be threaded up through cooling holes 28a and taped for future use.

The rotor/shaft assembly may then be inserted into center housing 28.

Field coils 27 may be made from cast magnetic material in a tube form. Each tube may be wound concentrically using unstranded copper wire for approximately 120 turns, for example. The field coil leads may be left extended for about ten inches. Each of the dual field coils may then be mounted on the front 34 or rear aluminum cast housing (see FIG. 2), respectively, along with a corresponding bearing 37. The field coil housing and bearing assembly may be held together by small bolts. The six stator leads may then be pulled through the front and rear housings 34, 36, and these housings may be bolted onto center housing 28.

12 power diodes, for example, rated at (e.g.) 150 amps may be placed around the outer perimeter of the front housing and screwed into a pattern as shown in FIG. 8. The negative diode may be screwed into the front of the actual housing face. The positive diodes may be screwed into a threaded copper plate held at a standoff at a distance behind the negative housing face approximately one-quarter inch, using phenolic spacers.

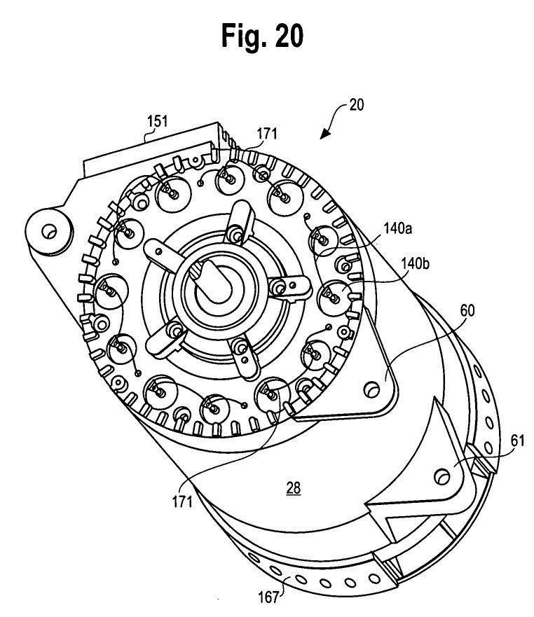

Stator leads 171 (see FIG. 20) may then be welded to each pair of one positive and one negative diode 140a, 140b, respectively, there being six pairs of such overall.

Referring to FIG. 4, a copper-coated bolt (not shown) may then be screwed into front housing copper positive plate 80 (see FIG. 6), which extends through the front housing. The copper-coated bolt may then be insulated from the front housing assembly by a high strength phenolic washer assembly (not shown). A retainer washer and nut may be used to clamp the copper bolt to the washer assembly. The copper bolt is known as the output post for positive DC current. A standard steel bolt (not shown) may be threaded into the front housing casting and not insulated; this bolt may be held in place by a retainer washer and a nut (also not shown). The steel bolt is known as the negative DC post.

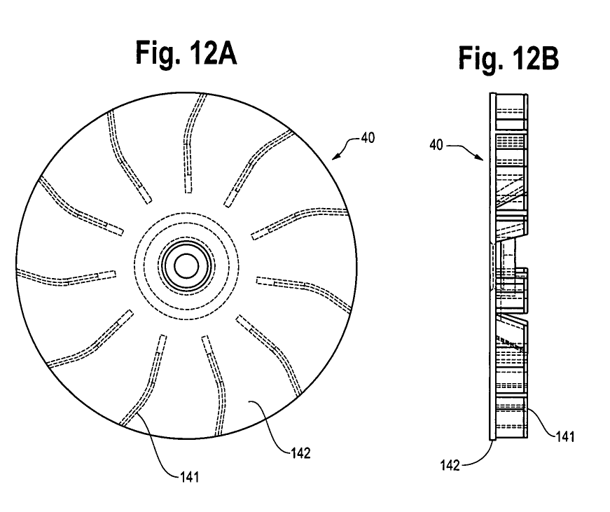

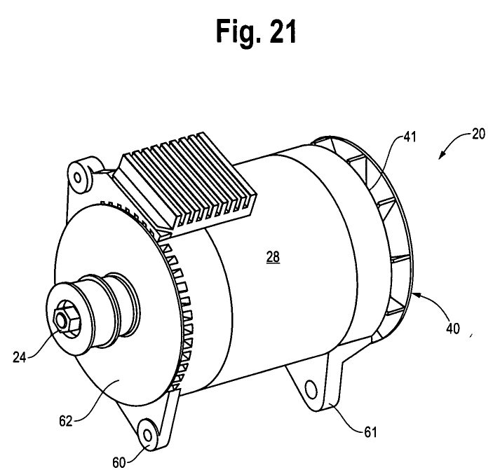

Referring to FIG. 2 and FIG. 21, front pulley 64 may then be attached to shaft 24, and rear fan assembly 40 (see FIG. 3) may be attached to the rear of shaft 24. Referring to FIGS. 12A and 12B, rear fan assembly 40 includes fins 141 on the face 142 of the fan oriented in such a way as to produce negative pressure from the rear of the alternator 20 and draw air from the front.

Referring to FIG. 22 and FIG. 1, the dual voltage regulator assembly may be etched on a printed circuit board 181 with leads 182, 183 to connect to the stator positive plate and the field coil leads. These connects 182, 183 may be soldered to field coil leads and stator leads together, and printed circuit board 181 may be mounted inside a flat aluminum cup 151 FIG. 1. The regulator PC board may include a heat sink on one side to dissipate heat and that board may then be bonded to the aluminum cup (151 FIG. 1). The regulator cup assembly may be bolted on to the front housing, as shown in FIG. 1 and FIG. 2.

Referring back to FIG. 6, battery positive terminal post may be connected to the positive DC output post 85 of the alternator, and the chassis ground may be connected to the steel negative DC post or front housing frame 60 of the alternator.

A brushless alternator constructed according to the present invention was found to provide a power output of 600 amps at 12 volts, while weighing, for example, only about 45 pounds, i.e., an efficiency of more than 12 amps/pound of alternator weight. 24 volt DC variation of this design was likewise found to be highly efficient, with efficiency in excess of 10 amps per pound of alternator weight.

It will be understood that various modifications to the preferred embodiment disclosed above may be made. The above description is not intended to limit the meaning of the words used in the following claims that define the invention. Rather, it is contemplated that future modifications in structure, function or result will exist that are not substantial changes and that all such insubstantial changes are intended to be covered by the following claims.

We claim:

1. An alternator adapted to be used in a vehicle, comprising:
a central housing;
first and second stators disposed within the central housing and sharing a shaft as a common longitudinal axis, the stators each having a winding and a stator winding output;
first and second rotors concentrically and respectively disposed within the first and second stators, for generating alternating current;
first and second wound field coils mounted in a stationary position in the housing and about the shaft, each of the first and second field coils being concentrically and respectively disposed within the first and second rotors to allow rotor rotation about the field coils; and
one or more voltage rectifier circuits connected to the stator winding outputs, and having a voltage rectifier output producing an output voltage for the alternator.

2. The alternator of claim 1, wherein each stator is wound with copper wire.

3. The alternator of claim 1, wherein the central housing includes cooling holes located in the perimeter of the housing for cooling an interior of the housing.

4. The alternator of claim 3, further comprising a cooling fan for pulling cooling air through the cooling holes and through the interior of the housing.

5. The alternator of claim 1, wherein the stators are comprised of multiple lamination stacks having multiple phases.

6. The alternator of claim 1, wherein the two stators each have a three-phase winding.

7. The alternator of claim 1, wherein the alternator comprises a high efficiency alternator capable of producing at least 10 amps per pound of alternator weight.

8. The alternator of claim 1, wherein the vehicle includes a vehicle engine installed in the vehicle for propelling the vehicle, the vehicle engine having an engine idling speed and an engine maximum speed, and the alternator being driven by the vehicle engine.

9. The alternator of claim 1, wherein the alternator has a maximum-rated output current.

10. The alternator of claim 1, wherein the rotors each include a wound field coil portion that is stationary.

11. The alternator of claim 1, wherein the one or more voltage rectifier circuits comprise one or more diodes operatively attached by welding to leads on the stators to convert the alternating current to direct current, and voltage regulators operatively attached to the diodes to control and regulate the generated voltage.

12. The alternator of claim 1, wherein the one or more voltage rectifier circuits comprise multiple phase rectifier bridges.

13. The alternator of claim 12, wherein the rectifier bridges comprise three-phase bridges rectifying three-phase AC to DC.

14. The alternator of claim 1, wherein electrical components used in the alternator are all redundant.

15. The alternator of claim 11, wherein electrical components used in each voltage regulator are discrete and redundant.

16. The alternator of claim 3, wherein cool ambient air is pulled from a front portion of the alternator, using a rear-mounted fan, through the central housing, to a rear of the alternator using the interior perimeter cooling holes.

17. The alternator of claim 3, wherein the cooling holes are cast or machined within the central housing.

18. The alternator of claim 3, further comprising a fan mounted on a single central shaft external to the alternator and located at a rear portion of the alternator.

19. The alternator of claim 3, wherein cool ambient air from outside the alternator is drawn over the voltage rectifier prior to entering the interior cooling holes.

20. The alternator of claim 1, wherein each stator has a three-phase winding.
